(19) United States
(12) Patent Application Publication
(10) Pub. No.: US 2026/0032431 A1
(43) Pub. Date: Jan. 29, 2026

(54) SYSTEM OF TRUST FOR FUSED SENSOR NETWORKS

(71) Applicant: BAE Systems Information and Electronic Systems Integration Inc., Nashua, NH (US)

(72) Inventor: Ryan Littler, Cedar Rapids, IA (US)

(73) Assignee: BAE SYSTEMS Information and Electronic Systems Integration Inc., Nashua, NH (US)

(21) Appl. No.: 18/784,512

(22) Filed: Jul. 25, 2024

(51) Int. Cl. H04W 12/03; G06F 21/60; H04L 9/00; H04W 24/04; H04W 84/18

(52) U.S. Cl. CPC H04W 12/03; G06F 21/602; H04L 9/50; H04W 24/04; H04W 84/18

(57) ABSTRACT

In an example, a sensor platform includes at least one sensor configured to acquire sensor data about an environment in which the sensor platform is located, a wireless communication interface, and a computing platform. The computing platform can be configured to control the sensor platform to acquire first sensor data using the at least one sensor, acquire second sensor data, via the wireless communication interface, from at least one other sensor platform, and display, via a user interface, a fused sensor view that includes the first sensor data and includes or excludes the second sensor data based on a level of trust assigned to the at least one other sensor platform and a trust setting of the sensor platform.

### FIELD OF DISCLOSURE

The present disclosure relates to sensor networks, and more particularly, to techniques for sharing data among sensor platforms.

### BACKGROUND

Various platforms, such as aircraft, ships, unmanned vehicles, land vehicles, etc., include one or more on-board sensors for collecting data about the environment in which the platform is deployed. There are numerous applications in which it may be desirable to share data acquired by individual platforms among a distributed group or network of multiple platforms. However, different platforms in the network may have different capabilities, different sensor resolution, different owners, and/or be experiencing different environmental conditions at any given time. Accordingly, it can be challenging to determine when the sensor data from other platforms can be reliably used. As a result, a number of non-trivial issues remain with respect to the distribution and fusion of sensor data over distributed networks.

### SUMMARY

Aspects and examples are directed to techniques for establishing a system of trust for data sharing and aggregation among a distributed network of sensor platforms.

According to one example, a sensor platform comprises at least one sensor configured to acquire sensor data about an environment in which the sensor platform is located, a wireless communication interface, and a computing platform configured to control the sensor platform to acquire first sensor data using the at least one sensor, acquire second sensor data, via the wireless communication interface, from at least one other sensor platform, and display, via a user interface, a fused sensor view that includes the first sensor data and includes or excludes the second sensor data based on a level of trust assigned to the at least one other sensor platform and a trust setting of the sensor platform.

Another example is directed to a method of data sharing in a distributed sensor network that includes a plurality of sensor platforms. In an example, the method comprises acquiring own sensor data about an environment in which the distributed sensor network is located using a sensor platform from among the plurality of sensor platforms, receiving a sensor ledger from at least one other sensor platform in the distributed sensor network, the sensor ledger comprising a plurality of ledger entries, wherein individual ledger entries of the plurality of ledger entries include a respective portion of other sensor data and an identifier that identifies an individual sensor platform from among the plurality of sensor platforms as a source of the respective portion of the other sensor data, wherein the individual ledger entries are cryptographically linked to one another in the sensor ledger, and producing, with the sensor platform, a fused sensor view based on the own sensor data and a selected portion of the other sensor data from the sensor ledger, wherein the selected portion of the other sensor data is selected by the sensor platform based on a trust setting of the sensor platform and levels of trust assigned by the sensor platform to respective other sensor platforms among the plurality of sensor platforms.

Another example is directed to a computer program product comprising one or more non-transitory machine-readable mediums having instructions encoded thereon that when executed by at least one processor cause a sensor platform to perform a method of data aggregation in a distributed sensor network. In an example, the method comprises acquiring, with the sensor platform, own sensor data about an environment in which the distributed sensor network is located, receiving, with the sensor platform, a sensor ledger from at least one other sensor platform in the distributed network, the sensor ledger comprising a plurality of ledger entries, wherein individual ledger entries of the plurality of ledger entries include a respective portion of other sensor data and an identifier that identifies an individual other sensor platform as a source of the respective portion of the other sensor data, and wherein the individual ledger entries are cryptographically linked to one another in the sensor ledger, and producing, with the sensor platform, a fused sensor view based on the own sensor data and a selected portion of the other sensor data from the sensor ledger, wherein the selected portion of the other sensor data is selected by the sensor platform based on a trust setting of the sensor platform and levels of trust assigned by the sensor platform to respective other sensor platforms in the distributed sensor network.

Still other aspects, examples, and advantages of these example aspects and examples are described in detail below. Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

In the figures:

FIG. 1 is a diagram illustrating an example of a distributed network of sensor platforms deployed in an environment, according to aspects of the present disclosure;

FIG. 2 is a block diagram of one example of a sensor platform, according to aspects of the present disclosure;

FIG. 3 is a diagram illustrating another example of the distributed network of sensor platforms deployed in an environment, according to aspects of the present disclosure;

FIGS. 4A-4C are diagrams illustrating aggregation of collections of sensor data from various contributing platforms, according to aspects of the present disclosure;

FIGS. 5A-C are diagrams illustrating examples of fused sensor views corresponding to aggregation of the collections of sensor data of FIGS. 4A-C, respectively, according to aspects of the present disclosure;

FIG. 6 is a sequence diagram illustrating an example of exchange of shared sensor data among a plurality of sensor platforms in a distributed a distributed sensor network, according to aspects of the present disclosure;

FIG. 7 is a diagram illustrating an example of an immutable sensor ledger, according to aspects of the present disclosure;

FIG. 8 is a flow diagram illustrating an example of a method that may be performed in a distributed sensor network, according to aspects of the present disclosure; and

FIG. 9 is a block diagram of one example of a computing platform according to aspects of the present disclosure.

Although the following detailed description will proceed with reference being made to illustrative examples, many alternatives, modifications, and variations thereof will be apparent in light of this disclosure.

### DETAILED DESCRIPTION

Techniques are disclosed herein for providing a system of trust by which sensor data can be shared and consolidated in real time among a distributed network of potentially disparate platforms.

According to certain examples, a sensor platform comprises at least one sensor configured to acquire sensor data about an environment in which the sensor platform is located. The sensor platform may further comprise a user interface, a wireless communication interface (e.g., for establishing wireless communication with other sensor platforms), and a computing platform coupled to the at least one sensor and the wireless communication interface. In some examples, the computing platform is configured to control the sensor platform to acquire first sensor data using the at least one sensor, acquire second sensor data, via the wireless communication interface, from at least one other sensor platform, and display, via the user interface, a fused sensor view that includes the first sensor data and includes or excludes the second sensor data based on a level of trust assigned to the at least one other sensor platform and a trust setting of the sensor platform.

These and other features of processes for are described in more detail below.

### General Overview

The growing ability to create ad-hoc data networks among dissimilar platforms, such as land, air, and/or water-going vehicles, provides opportunity to aggregate the various technology and fidelity of sensors carried by these platforms. For example, aggregated sensor data is used in crowd-sourced navigation applications to identify real-time traffic congestion and/or other road conditions to aid in navigation decisions. Examples of such applications may involve the use of sensor data from a vast number of contributing sensor platforms (e.g., other cars). Accordingly, the reliability of the sensor data from one any contributing sensor platform may not be of significant concern. Inaccuracies in the sensor data from one (or a few) contributing platform(s) among many may be naturally “filtered out” or deemphasized in the aggregation process because the combined result involves sensor data from such a large sample set. In addition, in applications such as identifying traffic congestion, the consequences of inaccuracies in the sensor data from a small number of contributing platforms may be insignificant (e.g., a minor annoyance to a driver whose system reports more or less traffic congestion than actually exists). However, in applications involving higher levels of safety or security, there often may be a far smaller number of contributing platforms in the network. As a result, the aggregation processes cannot rely on large sample sets (such as a congested freeway of drivers with mobile phones) to identify and filter out erroneous or suspect data. In addition, in certain such applications, the consequences of using inaccurate sensor data may be significant.

Accordingly, examples described herein provide techniques to establish levels of trust among sensor data contributors (contributing platforms) and to dynamically alter data aggregation processes based on a current selected trust level. These techniques may allow for reliable, robust sharing of sensor data in distributed complex sensor fusion networks. According to certain examples, a “chain of custody” is established for sensor data, such that the sensor data can be filtered according to trust level. For example, sensor data originating from, or being relayed by, a contributing platform that does not meet the specifications for a given trust level can be isolated and excluded from a data aggregation/fusion process. In this manner, sensor data from a wide variety of different contributing platforms with different capabilities (e.g., different sensors, sensor resolutions, or fields of view) can be dynamically incorporated into or excluded from a particular fused sensor view (e.g., a collection of aggregated, or “fused,” sensor data presented for display) in real time based on given circumstances. For example, in lower assurance environments (e.g., where a lower level of trust in some or all contributing platforms can be tolerated), a larger compilation of sensor data can be used, whereas in higher assurance environments or situations in which safety or security concerns are very high, sensor data used for aggregation can be limited to those contributing platforms in which there is a high level of trust. Because the selection of sensor data to be aggregated for any particular fused sensor view can be altered in real time, the benefits of incorporating data from many contributing platforms can be realized when appropriate, while retaining the ability to quickly reduce the pool of contributing platforms at any time, if needed.

Furthermore, according to certain examples, the level of trust associated with a particular contributing platform can also be dynamically altered based on circumstances or characteristics associated with that contributing platform. For example, a given contributing platform may generally be known to provide reliable sensor data and therefore be associated with a high level of trust. However, if it is known that the contributing platform is experiencing one or more conditions that may degrade the reliability of the sensor data (e.g., one or more sensors are malfunctioning or the contributing platform is in a location that could adversely affect the sensor data), the level of trust associated with the contributing platform can be downgraded until the condition(s) is/are resolved.

By dynamically enabling or disabling the use of certain sensor inputs (e.g., sensor data from certain contributing platforms) for aggregation into a fused sensor view based on a dynamically adjustable associated level of trust, techniques disclosed herein may provide a more resilient system in variable environments. As described further below, cryptographic techniques, such as public/private key cryptography and immutable ledgers, for example, can be used to establish to the chain of custody for sensor data and provide real-time revocation/suppression of sensor inputs based on level of trust. Techniques disclosed herein provide methods by which to allow a system to treat individual sensor feeds/inputs (e.g., those from different contributing platforms) differently, depending on circumstances. As a result, in some examples, the system may make the most of all available sensor data when circumstances permit, while also managing risk associated with different sources of the sensor data.

### Example System Architecture

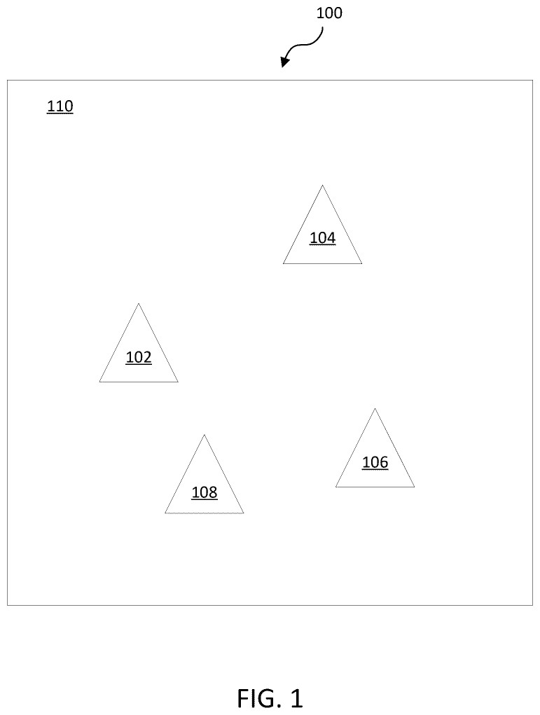

Referring to FIG. 1, there is illustrated a distributed sensor network 100 according to certain examples. The distributed sensor network 100 includes a plurality of sensor platforms 102, 104, 106, 108, located in an environment 110. The sensor platforms 102, 104, 106, 108 may be dissimilar platforms having different characteristics and/or capabilities. For example, any of the sensor platforms 102, 104, 106, 108 may be stationary platforms (e.g., associated with a building or other stationary structure) or mobile platforms (e.g., associated with some type of vehicle, such as a car, ship, aircraft, satellite, etc.). Any or all of the sensor platforms 102, 104, 106, 108 may contribute sensor data for use in producing a fused sensor view by any other(s) of the sensor platforms 102, 104, 106, 108, and therefore may be a contributing platform for one or more of the other sensor platforms 102, 104, 106, 108 at any time. For simplicity of illustration and explanation, the distributed sensor network 100 is shown in FIG. 1, and described herein, with the four sensor platforms 102, 104, 106, 108. However, it will be appreciated that the distributed sensor network 100 may include any number of sensor platforms, such as, for example, dozens of, hundreds of, thousands of, or more, sensor platforms. In addition, for simplicity of explanation, the following discussion may refer primarily to the sensor platform 102 as being a platform that collects and selectively aggregates sensor data collected by its own sensor(s) and received from one or more of the other sensor platforms 104, 106, 108. However, as noted above, any or all of the sensor platforms in the distributed sensor network 100 can be either or both of a contributing platform and/or an aggregating platform at any time.

The individual sensor platforms 102, 104, 106, 108 may have different capabilities and/or different owners/operators. For example, the individual sensor platforms 102, 104, 106, 108 may include different types of sensors (e.g., optical sensors vs radio frequency (RF) sensors vs acoustic sensors) and/or sensors with different resolutions and/or fields of view. Furthermore, the sensor data collected by each sensor platform 102, 104, 106, 108 may be different based on the different locations of the sensor platforms 102, 104, 106, 108 within the environment 110. Accordingly, by collecting and aggregating sensor data from others of the sensor platforms 102, 104, 106, 108 to produce a fused sensor view, any sensor platform may obtain potentially far more information about the environment 110 that it may be able to collect with only its own sensor(s), and thereby achieve greater situational awareness.

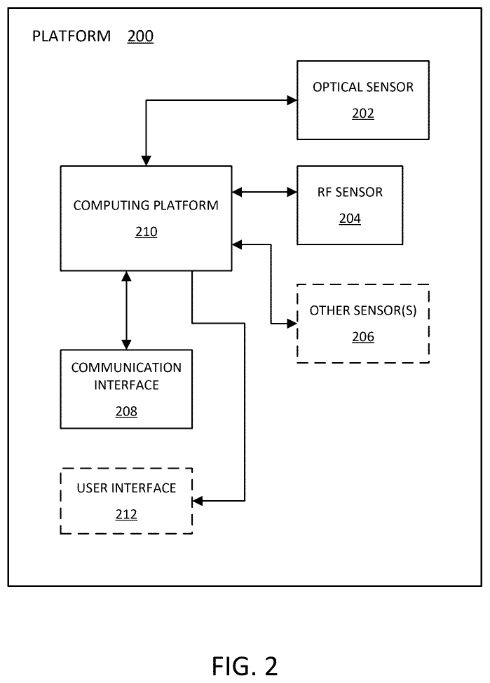

Referring to FIG. 2, there is illustrated a block diagram of an example of a sensor platform 200. The sensor platform 200 may be any of the sensor platforms 102, 104, 106, and/or 108, for example. In some examples, the sensor platform 200 includes one or more sensors for collecting information about the environment 110 and/or other sensor platforms. For example, the sensor platform 200 may include an optical sensor 202 and/or an RF sensor 204. The sensor platform 200 may optionally include one or more other sensors 206, such as a thermal sensor, acoustic sensor, or other type of sensor. In some examples, the sensor platform 200 may include the one or more other sensors 206 and omit either or both of the optical sensor 202 and/or the RF sensor 204. The sensor platform 200 may include a communication interface 208 configured to allow the sensor platform to transmit sensor data from the sensor platform 200 to external devices (such as one or more other sensor platforms) and/or to receive information from external devices (such as sensor data from one or more other sensor platforms). In some examples, the communication interface 208 is or includes a wireless communication interface that supports wireless communications via a wireless network, such as a personal area network (e.g., according to BLUETOOTH or other protocols) or WI-FI network (e.g., according to IEEE 802.11 or other protocols).

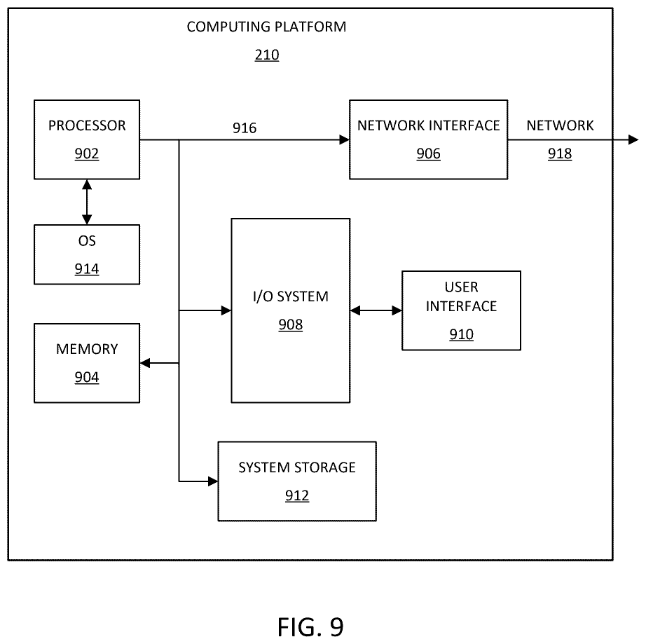

The sensor platform 200 may include a computing platform 210 that may control or facilitate various operations and/or functionality of the sensor platform 200, including, for example, aggregating sensor data from one or more sensors of the sensor platform 200 (e.g., the optical sensor 202, the RF sensor 204, and/or the one or more other sensor 206) and sensor data received (e.g., via the communications interface 208) from one or more other sensor platforms to produce a fused sensor view. Accordingly, the computing platform 210 may be coupled to the optical sensor 202, RF sensor 204, and/or other sensor(s) 206 and to the communication interface 208. The computing platform 210 may be configured to aggregate the sensor data based on levels of trust associated with the one or more other sensor platforms, as described further below. In addition, the computing platform may be configured to implement one or more cryptographic techniques to establish and/or verify a chain of custody associated with the sensor data, as also described further below. The computing platform 210 may include one or more processors, one or more computer-readable storage media for storing data and/or executable instructions, and optionally various other components. An example of the computing platform 210 is described below with reference to FIG. 9.

In certain examples, the sensor platform 200 is configured to display the fused sensor view for viewing by an operator of the sensor platform 200. Accordingly, the sensor platform 200 may optionally include a user interface 212 coupled to the computing platform 210. In other examples, the sensor platform 200 may be coupled to an external user interface 212. The user interface 212 may include a display screen for displaying the fused sensor view and optionally other information. The user interface 212 may further include one or more user input devices (e.g., a mouse, touchpad, graphical user interface, keyboard, or microphone) to allow the user to alter various parameters or operating characteristics of the sensor platform 200. For example, the user interface may allow the operator to alter a trust setting for creation and/or display of the fused sensor view, and/or individual levels of trust associated with one or more other sensor platforms.

As described above, two or more of the sensor platforms 102, 104, 106, 108 in the distributed sensor network 100 can share sensor data and optionally aggregate some or all of the shared sensor data to produce a fused sensor view. Data fusion/aggregation may occur at the individual platform level, or at the network level such that one or more sensor platforms 102, 104, 106, 108 can receive data representing a fused sensor view (referred to herein as a “picture”) from other sensor platforms. In certain circumstances, it can be advantageous to maximize sensor blending as much as practicable. For example, by allowing a given sensor platform 102, 104, 106, or 108 to use as much available shared sensor data as practicable, the sensor platform may gain greater situational awareness in the environment 110. However, as described above, there are also factors that may make it preferable to exclude potentially “suspect” or inaccurate sensor data in certain circumstances. For example, if sensor platforms 102 and 104 are owned/operated by different entities, sensor platform 102 may consider the sensor data acquired and shared by sensor platform 104 to be potentially suspect, at least for certain applications. Accordingly, in some low-risk applications, sensor platform 102 may use shared sensor data from sensor platform 104 in its fused sensor view. However, in high-risk applications or situations where fidelity of the sensor data to be used in critical decision making is highly important, sensor platform 102 may wish to exclude shared sensor data from sensor platform 104 in its fused sensor view. Through the use of trust settings and levels of trust associated with individual sensor platforms 102, 104, 106, 108, according to examples disclosed herein, decisions regarding which sensor data to use in or exclude from a fused sensor view can be made dynamically in real time.

According to certain examples, a sensor platform (such as sensor platform 102, for example) may assign respective levels trust to other sensor platforms in the distributed sensor network 100. The respective levels of trust may be based on various factors, which may be considered individually or in any combination. For example, these “trust factors” may include, among others, the identity of owner/operator entities associated with individual sensor platforms, the current geographic location of individual sensor platforms, environmental conditions associated with the current geographic location of the individual sensor platforms, and/or known sensor capabilities (e.g., resolution, accuracy, and/or type) of sensor(s) associated with individual sensor platforms. In some examples, the level of trust assigned by one sensor platform 102, 104, 106, 108 to any other sensor platform is particular to the assigning sensor platform, rather than being a network-level parameter. For example, sensor platform 102 may assign certain levels of trust to sensor platforms 104, 106, 108 based on one or more trust factors considered from the point of view of sensor platform 102. Sensor platform 104, for example, may assign the same or different levels of trust to sensor platforms 106, 108 as does sensor platform 102 because, from the point of view of sensor platform 104, the trust factors considered with respect to sensor platforms 106, 108 may be the same or different as they are from the point of view of sensor platform 102.

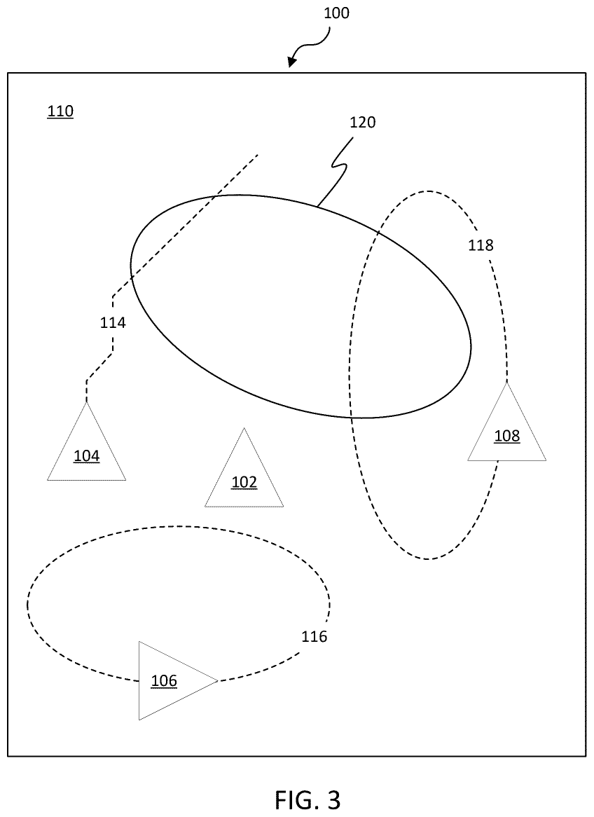

In some examples, the level of trust associated with any particular sensor platform can be altered at any time, for example, based on changing conditions or trust factors. Referring to FIG. 3, there is illustrated an example of the distributed sensor network 100 in the environment 110. In this example, the environment 110 includes a zone 120 known to be potentially impactful on sensor data acquired by a sensor platform inside the zone 120. For example, the zone 120 may represent an area where known sensor jamming or spoofing is in operation. In another example, the zone 120 may represent a severe weather pattern that could negatively impact some sensors. In the illustrated example, sensor platforms 104, 106, and 108 are mobile sensor platforms having trajectories 114, 116, and 118, respectively. As illustrated, the trajectories of sensor platforms 104 and 108 cross the zone 120. Accordingly, while the sensor platforms 104 or 108 are within the zone 120, their sensor data may be suspect, even if it would otherwise not be. Considering sensor platform 102, for example, based on knowledge of the trajectories 114, 118, respectively, of the sensor platforms 104, 108, or knowledge of the real-time geographic location(s) of the sensor platforms 104, 108, sensor platform 102 may alter (e.g., downgrade) the level of trust it assigns to the sensor platforms 104, 108 when the sensor platforms 104, 108 are known (or expected) to be within the zone 120. For example, the sensor platform 102 may temporarily assign a lower level of trust to the sensor platform 104 or 108 based on information about the location of the sensor platform. Thus, the level of trust that a sensor platform assigns to any other sensor platform need not be a static parameter, but may be altered dynamically based on information about changing conditions or characteristics associated with the other sensor platform(s).

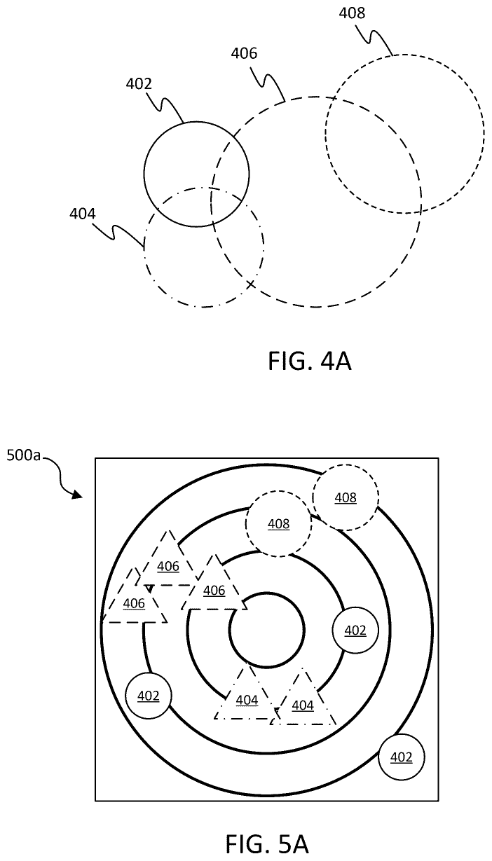

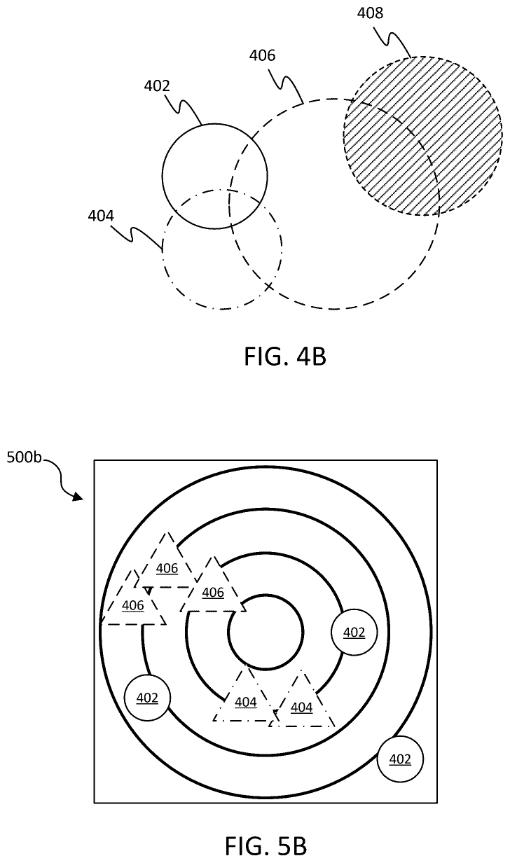

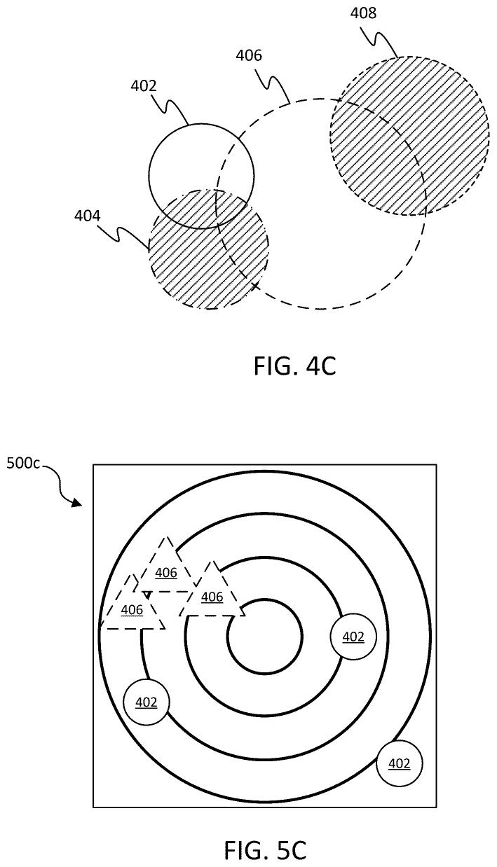

A sensor platform 200 may be configured to assign any one of a number of trust levels to other sensor platforms. In one example, the trust level may be binary condition, such as “trusted” or “not trusted.” In other examples, there may be multiple trust levels, such as “high,” “medium,” and “low,” for example. There may be any number of different trust levels (e.g., 3, 4, 5, 10, etc.). In addition to assigning trust levels to other sensor platforms (and therefore to the sensor data received from those sensor platforms), a sensor platform 200 may be configured with a particular trust setting that determines what sensor data is used to produce that sensor platform's fused sensor view. For example, a sensor platform 200 may be configurable with high, medium, and low trust settings. In some examples, the trust setting is dynamically variable. For example, the trust setting may be altered by an operator of the sensor platform 200 via the user interface 212. In some examples, for a given trust setting, the sensor platform 200 may use only acquired sensor data that is associated with a trust level compatible with the current trust setting in its fused sensor view. Examples are illustrated in FIGS. 4A-4C and 5A-5C. In these examples, the sensor platform 102 acquires sensor data from its own sensor(s) and shared sensor data from the other sensor platforms 104, 106, 108, and selectively aggregates the sensor data to produce fused sensor views 500 (FIGS. 5A-C) depending on its current trust setting.

FIG. 4A is a diagram illustrating collections of sensor data acquired by/from the sensor platforms 102, 104, 106, 108. In the illustrated example, data 402 is acquired by the sensor platform 102, data 404 is shared sensor data acquired from the sensor platform 104, data 406 is shared sensor data acquired from the sensor platform 106, and data 408 is shared sensor data acquired from the sensor platform 108. In some examples, when the sensor platform 102 is configured with a low trust setting, the sensor platform aggregates all the data 402, 404, 406, 408 to produce a fused sensor view. For example, in applications such as search and rescue missions or environment surveys, it may be beneficial to use all available shared sensor data, since any data may assist in the mission and the risk/consequence associated with potentially suspect data may be very low (or out-weighted by the potential benefit). An example of a corresponding fused sensor view 500a is illustrated in FIG. 5A. As shown, in this example, since the trust setting for the sensor platform 102 is low, the fused sensor view 500a includes the shared data 404, 406, 408 from all the contributing sensor platforms 104, 106, 108, respectively, along with the sensor platform's own sensor data 402. In the example of FIG. 5A, the fused sensor view 500a is presented as a “tactical” style view; however, in other examples, any of numerous other display formats may be used.

Referring to FIGS. 4B and 5B, in some instances, the sensor platform 102 may be configured with a higher trust setting than in the example shown in FIGS. 4A and 5A. For examples, the sensor platform 102 may be configured with a medium trust setting. In such instances, the sensor platform 102 may be configured to exclude sensor data from one or more sensor platforms that are not currently assigned a sufficiently high trust level. For example, as shown in FIG. 4B, the sensor platform 102 may exclude from aggregation the data 408 transmitted by the sensor platform 108. Accordingly, the corresponding fused sensor view 500b, shown in FIG. 5B, does not show the data 408 from the sensor platform 108.

FIGS. 4C and 5C illustrate an example in which the sensor platform 102 is configured with a high trust setting. For example, a high trust setting may be used in applications or situations involving high risk or significant consequences, such as tactical military operations, for example, in which it may be important to rely only on sensor data in which there is a very high level of confidence. In such situations, in contrast to low trust setting applications, the risks associated the use of potentially suspect data may outweigh any potential added context or situational awareness provided by such data. Accordingly, the sensor platform 200 may significantly constrain the shared data sets to be used in the fused sensor view and exclude any shared data from a sensor platform that does not have a sufficiently high level of trust associated therewith. For example, the sensor platform 200 may use shared sensor data only from other sensor platforms that are currently assigned a high trust level, while excluding shared sensor data from other sensor platforms that are assigned a medium or low trust level. Thus, in the example of FIG. 4C, the sensor platform 102 is configured to exclude data 404 and 408 from sensor platforms 104 and 108, respectively. Accordingly, in this example, the corresponding fused sensor view 500c of FIG. 5C shows only the sensor platform's own data 402 and the shared data 406 from the sensor platform 106, and does not show the data 404 or 408 from the sensor platforms 104 and 108, respectively.

Thus, depending on current circumstances, application/mission, and/or available information about the environment 110 and/or other sensor platforms 104, 106, 108 in the distributed sensor network 100, the trust setting sensor platform 102 can be dynamically altered. Changing the trust setting, in turn, configures the sensor platform 102, in real time, to adapt its selection of data to aggregate, and corresponding fused sensor view, in accord with the current trust setting. This allows the fused sensor view to be swiftly and seamlessly modified, optionally over a range of different trust settings, to allow an operator of the sensor platform 102 to expand or contract the collection of data shown. The trust setting may be selected for a particular application or operation, or may be modified during that application or operation as needed/desired by the operator, for example. Similarly, as described above, the level of trust assigned to any given sensor platform can be dynamically varied as information about that sensor platform may change (e.g., as the trajectories of sensor platforms 104 or 108 move those respective sensor platforms into or out of the zone 120). Thus, the displayed fused sensor view may change in real time even if the trust setting remains constant.

According to certain examples, transmissions from contributing sensor platforms 102, 104, 106, 108 include an identifier, along with the sensor data payload, that identifies the sensor platform 102, 104, 106, 108 that is the source of the transmission. In addition, an aggregating sensor platform (e.g., sensor platform 102) may store information that links individual identifiers with the current level of trust assigned to the corresponding sensor platform. For example, this information may be stored in a look-up table or other data structure stored in the computing platform 210. In some examples, the received sensor data 402, 404, 406, 408 is tagged with a corresponding sensor platform identifier, such that the aggregating sensor platform 102 can filter the received sensor data to exclude any sensor data from sensor platforms that do not have a sufficiently high current level of trust, depending on the trust setting of the aggregating sensor platform 102.

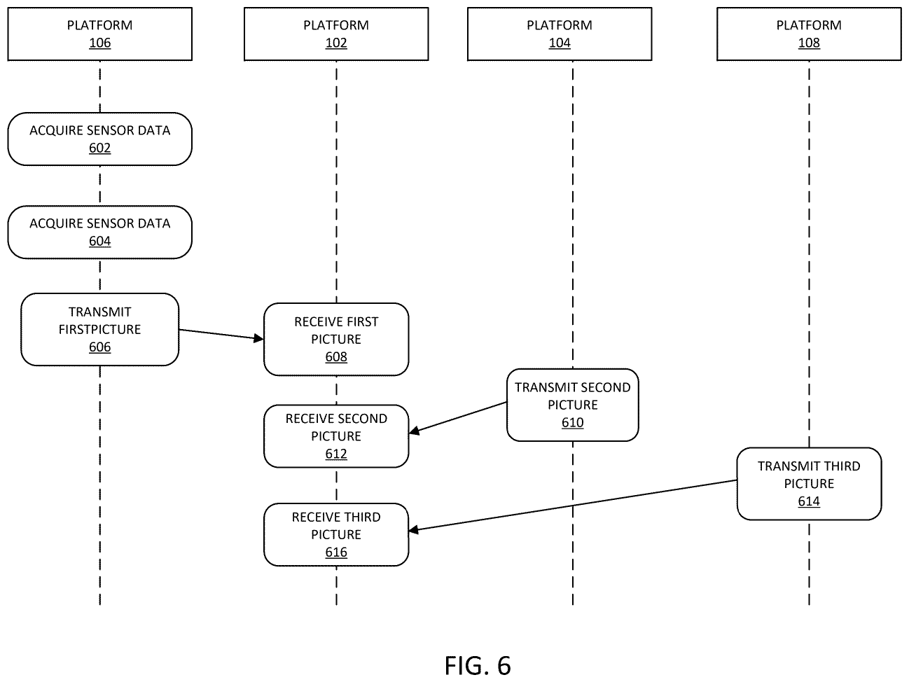

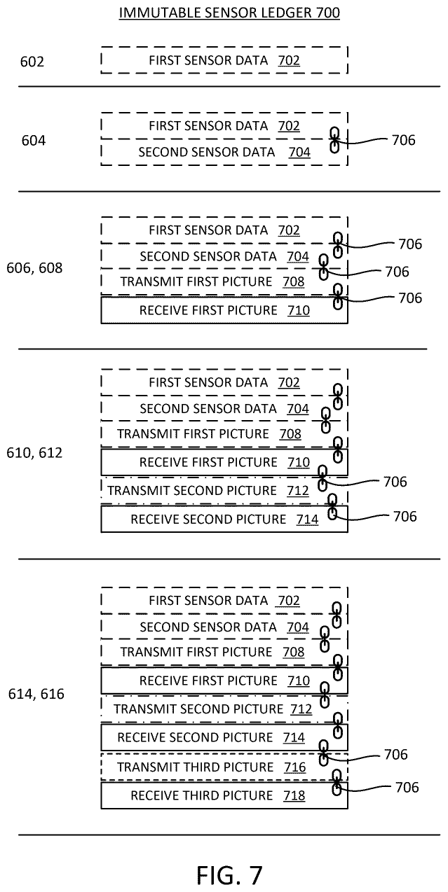

As described above, according to certain examples, a chain of custody can be established for the shared sensor data. This chain of custody may allow aggregating sensor platforms to identify the contributing sensor platform that shared an individual piece of sensor data, to verify the identify of the contributing sensor platform, and to filter the sensor data based on levels of trust, as described above. In some examples, this chain of custody is implemented using an immutable sensor ledger that is shared among the contributing sensor platforms 102, 104, 106, 108 in the distributed sensor network 100. In some examples, the immutable sensor ledger contains ledger entries that are blocks of sensor data and corresponding transactions (e.g., transmission/reception of the block of sensor data) as the data progresses through the distributed sensor network 100. Thus, the ledger entries may reflect a chronological buildup of sensor data in the distributed sensor network 100. An example of an immutable sensor ledger, and process for building the ledger, is described further below with reference to FIGS. 6 and 7.

In some examples, as ledger entries are added to the ledger, the entries are digitally signed by the contributing sensor platform (e.g., such that each ledger entry includes the identifier identifying the respective contributing platform) and cryptographically bound to previous ledger entries. For example, the immutable sensor ledger may be produced and distributed using cryptographic techniques such as blockchain, for example. Using a blockchain approach, each ledger entry may contain a cryptographic hash of the previous entry, a timestamp, and transaction data, along with the sensor data payload. In some examples, since each ledger entry contains information about the previous entry, the entries together effectively form a chain, with each additional ledger entry linking to the ones before it. Consequently, blockchain transactions are irreversible in that, once they are recorded, the data in any given entry cannot be altered retroactively without altering all subsequent entries. As such, the sensor ledger may be considered “immutable” and secure by design. Contributing sensor platforms 102, 104, 106, 108 in the distributed sensor network 100 may adhere to a consensus protocol to add and validate new ledger entries to the immutable sensor ledger.

According to certain examples, digital signatures applied by the contributing sensor platform(s), along with checks of the digital signatures by aggregating sensor platform(s), provide nonrepudiation of the sensor data and transactions contained in the ledger entries. Nonrepudiation refers to a mechanism by which proof of the origin and integrity of data can be established. In some examples, a system of public/private keys can be used to establish levels of trust for contributing sensor platforms 102, 104, 106, 108 in the distributed sensor network 100. For example, certain keys may be provided by the sensor platform 102 to one or more of the other sensor platforms 104, 106, 108, depending on the level of trust the sensor platform 102 has assigned to the respective other sensor platforms 104, 106, 108. Accordingly, when the sensor platform 102 receives sensor data from a contributing platform 104, 106, 108, the sensor platform 102 may verify that a valid key accompanies the sensor data. Lack of a valid key (or revocation of a key by the sensor platform 102 in the event of a changing level of trust assigned to any particular sensor platform) may provide a mechanism by which the sensor platform 102 can reject or exclude sensor data from certain contributing sensor platforms 104, 106, 108 when assembling its fused sensor view, depending on the current trust setting, as described above with reference to FIGS. 4A-5C. In some examples, keys can have a certain effectivity (or validity) time period or date, thereby providing a mechanism by which to bound or limit trust relationships between certain sensor platforms 102, 104, 106, 108 to specific operational windows.

Thus, aspects and examples provide a system of trust for distributed sensor networks and process for establishing a chain of custody for sensor data. The techniques disclosed herein may allow for real-time nonrepudiation of the sensor data and filtering for isolation of potentially suspect data blocks. By providing for real-time, dynamic inclusion or exclusion of sensor data from a fused sensor view based on qualification of trust and/or known sensor/platform limitations in contested or challenging environments, examples provide for a more resilient system in variable environments.

### Example Methodology

Referring to FIG. 6, there is illustrated a sequence diagram of a process for building and distributing an immutable sensor ledger 700 (see FIG. 7) in the distributed sensor network 100. As described above, by using the immutable sensor ledger 700 and system of trust among sensor platforms 102, 104, 106, 108 in the distributed sensor network 100, access to a potentially large collection of data for use in fused sensor views can be obtained, while mitigating risk associated with potentially suspect shared data. FIG. 7 shows an example of the immutable sensor ledger 700, illustrating the addition of sensor data and transactions to the ledger according to the example process illustrated in FIG. 6. Accordingly, the following example is described with reference to FIGS. 6 and 7.

In this example, at operation 602, the sensor platform 106 acquires first sensor data using one or more sensors. The sensor platform 106 adds a first ledger entry 702 to the immutable ledger 700. The first ledger entry 702 includes a first sensor data block, which as described above, may includes the sensor data payload along with an identifier (e.g., a key and/or other identifying information) that identifies the sensor platform 106 as the source of the first ledger entry 702 and the associated sensor data block. In the example illustrated in FIG. 7, the ledger entries in the immutable ledger 700 are represented using line styles (e.g., dashed, solid, etc.) that match the line styles used to represent the sensor data 402, 404, 406, 408 from the respective sensor platforms 102, 104, 106, 108 in FIGS. 4A-5C, thereby indicating the identifier associated with individual ledger entries.

At operation 604, the sensor platform 106 acquires second sensor data using one or more sensors, which may the same or different sensor(s) as used to acquire the first sensor data. Accordingly, the sensor platform 106 adds a second ledger entry 704 to the immutable ledger 700. Like the first ledger entry 702, the second ledger entry 704 may include a sensor data block that includes the respective sensor data payload, along with an identifier that identifies the sensor platform 106 as the source of the second ledger entry 704 and the associated sensor data block. In addition, the second ledger entry 704 is linked to the first ledger 702 in the immutable ledger 700, as indicated by link 706. As described above, the link 706 may represent a cryptographic technique applied to the second ledger entry 704, such as a cryptographic hash of the previous ledger entry or entries (e.g., the first ledger entry 702 in the example of FIG. 7), a timestamp, and transaction data (e.g., indicating that the transaction associated with the second ledger entry 704 is addition of a sensor data block), for example.

In some examples, the sensor platform 106 may aggregate the sensor data acquired at operations 602 and 604 to a combined sensor data set, referred to herein as a picture. As described above, in some instances, the picture represents a fused sensor view produced by the respective sensor platform, in this instance, the sensor platform 106. In the example illustrated in FIGS. 6 and 7, a first picture produced by the sensor platform 106 includes sensor data from the sensor platform's own sensors. However, in other examples, the first picture may include aggregated sensor data from other contributing sensor platforms.

At operation 606, the sensor platform 106 transmits the first picture to the sensor platform 102, as shown in FIG. 6. In addition, the sensor platform 106 adds a third ledger entry 708 to the immutable ledger 700 indicating transmission of the first picture. For example, the third ledger entry 708 may include a sensor data block corresponding to the first picture and an identifier that identifies the sensor platform 106 as the source of the first picture, as described above. In addition, the third ledger entry 708 is linked to the second ledger 704 in the immutable ledger 700, as indicated by the link 706. As described above, in some examples, the link 706 represents a cryptographic link between the second and third ledger entries 704, 708. As also described above, in some examples, the link 706 includes transaction data, which in this example, may include information indicating that the first picture was transmitted (at operation 606) by the sensor platform 106.

At operation 608, the sensor platform 102 receives the first picture transmitted/shared by the sensor platform 106. Accordingly, the sensor platform 102 may add a fourth ledger entry 710 to the immutable ledger, indicating that the sensor platform 102 received the first picture. Thus, the fourth ledger entry 710 may include an identifier that identifies the sensor platform 102 as having added the fourth ledger entry 710 to the immutable ledger 700. As described above, the fourth ledger entry 710 may be cryptographically linked to the third ledger entry 708, as indicated by the link 706.

The above described process and operations may be repeated as the sensor platform 102 receives sensor data from one or more of the other contributing sensor platforms 104, 106, 108. For example, as shown in FIG. 6, at operation 610, the sensor platform 104 may transmit a second picture. Accordingly, the sensor platform 104 may add a fifth ledger entry 712 to the immutable sensor ledger 700 indicating transmission of the second picture by the sensor platform 104. At operation 612, the sensor platform 102 may receive the second picture, and add a sixth ledger entry 714 to the immutable sensor ledger 700 indicating receipt of the second picture by the sensor platform 102.

Similarly, at operation 614, the sensor platform 108 may transmit a third picture to the sensor platform 102. Accordingly, the sensor platform 108 may add a seventh ledger entry 716 to the immutable sensor ledger 700 indicating transmission of the third picture by the sensor platform 108. At operation 616, the sensor platform 102 may receive the third picture, and add a corresponding eighth ledger entry 716 to the immutable sensor ledger 700. The process may continue as additional sensor data is shared among the various sensor platforms 102, 104, 106, 108 in the distributed sensor network 100.

According to certain examples, because individual ledger entries in the immutable sensor ledger 700 include respective identifiers, as described above, the sensor platform 102 can easily filter the sensor data blocks received with the sensor ledger to include only selected sensor data (e.g., data from those sensor platforms having a sufficiently high assigned level of trust) in its fused sensor view.

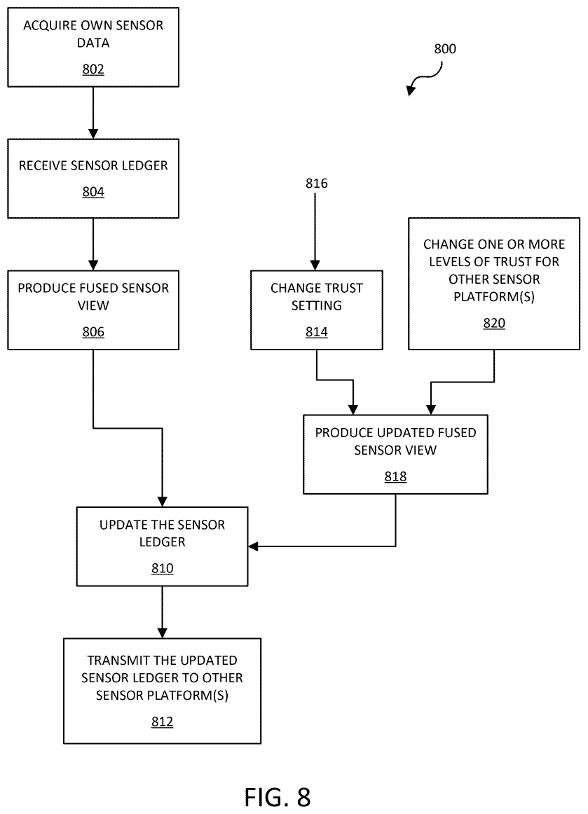

Referring to FIG. 8, there is illustrated a flow diagram of an example of a data sharing process 800 that may be implemented by one or more sensor platforms 200 (e.g., sensor platform 102) in the distributed sensor network 100. For case of explanation, the following example refers to the sensor platform 102; however, it will be appreciated that the operations described below may be implemented by any one or more sensor platforms in the distributed sensor network 100.

At operation 802, the sensor platform 102 acquires own sensor data about the environment 110, for example, using one or more of the sensors 202, 204, and/or 206, as described above.

At operation 804, the sensor platform 102 receives the sensor ledger 700 from at least one other sensor platform (e.g., sensor platforms 104, 106, and/or 108) in the distributed sensor network 100. As described above, the sensor ledger 700 may comprise a plurality of ledger entries. Individual ledger entries may include a respective portion of other sensor data (from other sensor platforms 104, 106, or 108, for example) and an identifier that identifies the corresponding individual sensor platform as the source of the respective portion of the other sensor data. As also described above with reference to FIG. 7, the individual ledger entries may be cryptographically linked to one another in the sensor ledger 700.

At operation 806, the sensor platform 102 produces a fused sensor view 500 (e.g., as shown in any of FIGS. 5A-C) based on its own sensor data acquired at operation 802 and a selected portion of the other sensor data from the sensor ledger 700. As described above with reference to FIGS. 4A-C and 5A-C, the selected portion of the other sensor data may be selected by the sensor platform 102 based on a trust setting of the sensor platform 102 and levels of trust assigned by the sensor platform 102 to the respective other sensor platforms 104, 106, 108. As also described above, in some examples, the sensor platform 102 is configured to assign levels of trust to the other sensor platforms 104, 106, and/or 108 based on one or more trust factors, which may include factors such as locations of the sensor platforms, operators of the sensor platforms, sensor capabilities of the sensor platforms, and/or environmental conditions affecting the sensor platforms.

At operation 810, the sensor platform 102 may update the sensor ledger 700 to produce an updated sensor ledger by recording its own sensor data as an additional ledger entry in the sensor ledger 700, as described above with reference to FIGS. 6 and 7. As also described above, in some examples, the additional ledger entry includes the own sensor data and an identifier that identifies the sensor platform 102 as the source of the own the sensor data. In some examples, updating the sensor ledger 700 at operation 810 includes cryptographically linking the additional ledger entry to at least one other ledger entry in the updated sensor ledger 700. As described above with reference to FIG. 7, in some examples, cryptographically linking the additional ledger entry to the at least one other ledger entry includes producing a cryptographic hash of the at least one other ledger entry and including the cryptographic hash in the additional ledger entry.

At operation 812, the sensor platform 102 transmits the updated sensor ledger 700 to one or more of the other sensor platforms 104, 106, 108 in the distributed sensor network 100.

As described above, with reference to FIGS. 4A-C and 5A-C, in some instances, a user may change the trust setting of the sensor platform 102, which may alter the portion(s) of the other sensor data that the sensor platform 102 selects/uses to produce its fused sensor view. Accordingly, in some examples, the process 800 includes an operation 814 of changing the trust setting of the sensor platform 102 based on a user input 816.

At operation 818, the sensor platform 102 produces an updated fused sensor view based on the new trust setting. In some examples, the sensor platform 102 may update the sensor ledger 700 (e.g., at operation 810 as shown) to include a new ledger entry corresponding to the updated fused sensor view. In some examples, the sensor platform 102 may produce the updated fused sensor view at operation 818 based changing the level of trust associated with any one or more of the other sensor platforms 104, 106, 108 (in addition to or instead of a changed trust setting of the sensor platform 102). As described above, the sensor platform 102 may dynamically change the level of trust assigned to any other sensor platform based on any one or more of various trust factors. Accordingly, in some examples, the process 800 includes an operation 820 of changing, by the sensor platform 102, the level of trust assigned to one or more other sensor platforms 104, 106, and/or 108. The fused sensor view produced at operation 818 may thus be updated (e.g., to include or exclude certain portions of other sensor data from one or more of the other sensor platforms) based on the changed level(s) of trust.

### Example Computing Platform

FIG. 9 illustrates an example computing platform 210 that can be used to implement some functionality of the sensor platform 200 described herein. In some examples, the computing platform 210 may host, or otherwise be incorporated into a personal computer, workstation, server system, laptop computer, ultra-laptop computer, tablet, touchpad, portable computer, handheld computer, palmtop computer, personal digital assistant (PDA), cellular telephone, combination cellular telephone and PDA, smart device (for example, smartphone or smart tablet), mobile internet device (MID), messaging device, data communication device, imaging device, wearable device, embedded system, and so forth. Any combination of different devices may be used in certain examples. In some examples, the computing platform 210 represents one system in a network of systems coupled together via controlled area network (CAN) bus or other network bus.

In some examples, the computing platform 210 may comprise any combination of a processor 902, a memory 904, a network interface 906, an input/output (I/O) system 908, a user interface 910, and a storage system 912. As shown in FIG. 9, a bus and/or interconnect 916 is also provided to allow for communication between the various components listed above and/or other components not shown. The computing platform 210 can be coupled to a network 918 (e.g., a wireless network or communication link, as described above) through the network interface 906 to allow for communications with other computing devices, platforms, or resources. Other componentry and functionality not reflected in the block diagram of FIG. 9 will be apparent in light of this disclosure, and it will be appreciated that other examples are not limited to any particular hardware configuration.

The processor 902 can be any suitable processor and may include one or more coprocessors or controllers to assist in control and processing operations associated with the computing platform 210. In some examples, the processor 902 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core.

The memory 904 can be implemented using any suitable type of digital storage including, for example, flash memory and/or random access memory (RAM). In some examples, the memory 904 may include various layers of memory hierarchy and/or memory caches as are known to those of skill in the art. The memory 904 may be implemented as a volatile memory device such as, but not limited to, a RAM, dynamic RAM (DRAM), or static RAM (SRAM) device. The storage system 912 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some examples, the storage system 912 may comprise technology to increase the storage performance enhanced protection for valuable digital media when multiple hard drives arc included. The storage system 912 and/or the memory 904 may store sensor data, information regarding the trust setting, information regarding levels of trust assigned to other sensor platforms, and/or cryptographic information, such as information about the keys used for nonrepudiation of shared sensor data, or other information needed to use the immutable ledger 700, as described above.

The processor 902 may be configured to execute an Operating System (OS) 914 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with the computing platform 210, and therefore may also be implemented using any suitable existing or subsequently-developed platform.

The network interface 906 can be any appropriate network chip or chipset which allows for wired and/or wireless connection between other components of the computing platform 210 and/or the network 918, thereby enabling the computing platform 210 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks. In some examples, the network interface 906 is part of the communication interface 208, or the communication interface (or part(s) thereof) is part of the network interface 906. Accordingly, the network interface 906 may be configured to allow the sensor platform 200 to transmit and receive sensor data and/or the immutable ledger 700 to and from other sensor platforms 200, as described above.

The I/O system 908 may be configured to interface between various I/O devices and other components of the computing platform 210. I/O devices may include, but not be limited to, a user interface 910. The user interface 910 may include devices (not shown) such as a display element, touchpad, keyboard, mouse, and/or speaker, to allow a user to interact with the computing platform 210. In some examples, the user interface 910 may include, or may be part of, the user interface 212 described above.

It will be appreciated that in some examples, the various components of the computing platform 210 may be combined or integrated in a system-on-a-chip (SoC) architecture. In some examples, the components may be hardware components, firmware components, software components or any suitable combination of hardware, firmware or software.

In various examples, the computing platform 210 may be implemented as a wireless system, a wired system, or a combination of both. When implemented as a wireless system, the computing platform 210 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, the computing platform 210 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The examples are not limited in this context.

The terms “circuit” or “circuitry,” as used in any example herein, may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, and/or firmware, configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, and/or smart phones. Other examples may be implemented as software executed by a programmable control device. As described herein, various examples may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Various examples may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, GPUS, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an example is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

### Further Examples

The following examples pertain to further aspects or examples, from which numerous permutations and configurations will be apparent.

Example 1 is a sensor platform comprising at least one sensor configured to acquire sensor data about an environment in which the sensor platform is located, a wireless communication interface, and a computing platform. The computing platform is configured to control the sensor platform to acquire first sensor data using the at least one sensor, acquire second sensor data, via the wireless communication interface, from at least one other sensor platform, and display, via a user interface, a fused sensor view that includes the first sensor data and includes or excludes the second sensor data based on a level of trust assigned to the at least one other sensor platform and a trust setting of the sensor platform.

Example 2 includes the sensor platform of Example 1, wherein the sensor platform includes the user interface.

Example 3 includes the sensor platform of one of Examples 1 or 2, wherein the second sensor data includes a first portion from a first other sensor platform assigned a first level of trust, and a second portion from a second other sensor platform assigned a second level of trust that is a higher trust level than the first level of trust, and wherein, the computing platform is configured to, based on the trust setting of the sensor platform being a first trust setting, display the fused sensor view including the first and second portions of the second sensor data, or based on the trust setting of the sensor platform being a second trust setting, higher than the first trust setting, display the fused sensor view including the second portion of the second sensor data and excluding the first portion of the second sensor data.

Example 4 includes the sensor platform of Example 3, wherein the first portion of the second sensor data includes a first identifier that identifies the first other sensor platform, and the second portion of the second sensor data includes a second identifier that identifies the second other sensor platform.

Example 5 includes the sensor platform of Example 4, wherein the computing platform includes a computer-readable storage medium that stores information linking the first level of trust to the first identifier and the second level of trust to the second identifier.

Example 6 includes the sensor platform of one of Examples 4 or 5, wherein the second sensor data includes a sensor ledger in which the first portion of the second sensor data is cryptographically linked to the first identifier, and the second portion of the second sensor data is cryptographically linked to the second identifier and to the first portion of the second sensor data.

Example 7 includes the sensor platform of Example 6, wherein to cryptographically link the second portion of the second sensor data to the first portion of the second sensor data, a ledger entry including the second portion of the second sensor data includes a cryptographic hash of the first portion of the second sensor data.

Example 8 includes the sensor platform of any one of Examples 3-7, wherein the computing platform is configured to temporarily assign the first level of trust to the second other sensor platform based on location information about the second other sensor platform.

Example 9 includes the sensor platform of any one of Examples 1-8, wherein the computing platform is configured to add the first sensor data as a ledger entry to a sensor ledger, wherein the ledger entry includes an identifier that identifies the sensor platform and is cryptographically linked to at least one previous ledger entry in the sensor ledger, and transmit the sensor ledger, including the ledger entry, to the at least one other sensor platform via the wireless communication interface.

Example 10 includes the sensor platform of any one of Examples 1-9, wherein the computing platform is configured to change the trust setting based on a user input received via the user interface.

Example 11 is a method of data sharing in a distributed sensor network that includes a plurality of sensor platforms. The method comprises acquiring own sensor data about an environment in which the distributed sensor network is located using a sensor platform from among the plurality of sensor platforms, receiving a sensor ledger from at least one other sensor platform in the distributed sensor network, the sensor ledger comprising a plurality of ledger entries, wherein individual ledger entries of the plurality of ledger entries include a respective portion of other sensor data and an identifier that identifies an individual sensor platform from among the plurality of sensor platforms as a source of the respective portion of the other sensor data, wherein the individual ledger entries are cryptographically linked to one another in the sensor ledger, and producing, with the sensor platform, a fused sensor view based on the own sensor data and a selected portion of the other sensor data from the sensor ledger, wherein the selected portion of the other sensor data is selected by the sensor platform based on a trust setting of the sensor platform and levels of trust assigned by the sensor platform to respective other sensor platforms among the plurality of sensor platforms.

Example 12 includes the method of Example 11, further comprising, with the sensor platform, updating the sensor ledger to produce an updated sensor ledger by recording the own sensor data as an additional ledger entry in the sensor ledger, the additional ledger entry including the own sensor data and an identifier that identifies the sensor platform as a source of the own the sensor data, wherein updating the sensor ledger further includes cryptographically linking the additional ledger entry to at least one other ledger entry of the plurality of ledger entries in the updated sensor ledger.

Example 13 includes the method of Example 12, wherein cryptographically linking the additional ledger entry to the at least one other ledger entry includes producing a cryptographic hash of the at least one other ledger entry and including the cryptographic hash in the additional ledger entry.

Example 14 includes the method of one of Examples 12 or 13, further comprising transmitting the updated sensor ledger from the sensor platform to one or more other sensor platforms in the distributed sensor network.

Example 15 includes the method of any one of Examples 11-14, wherein the other sensor data includes a first portion from a first other sensor platform in the plurality of sensor platforms and a second portion from a second other sensor platform in the plurality of sensor platforms, wherein the first other sensor platform is assigned a first level of trust by the sensor platform, and the second other sensor platform is assigned a second level of trust by the sensor platform, the second level of trust being higher trust level than the first level of trust, and wherein, producing the fused sensor view comprises, based on the trust setting of the sensor platform being a first trust setting, selecting the selected portion of the other sensor data to include the first and second portions of the other sensor data, or based on the trust setting of the sensor platform being a second trust setting, higher than the first trust setting, selecting the selected portion of the other sensor data to include the second portion of the other sensor data and exclude the first portion of the other sensor data.

Example 16 includes the method of any one of Examples 11-15, further comprising changing the trust setting of the sensor platform based on a user input.

Example 17 includes the method of any one of Examples 11-16, wherein the sensor platform is configured to assign the first level of trust to the first other sensor platform and to assign the second level of trust to the second other sensor platform based on one or more trust factors, wherein the trust factors include locations of the plurality of sensor platforms, operators of the plurality of sensor platforms, sensor capabilities of the plurality of sensor platforms, and/or environmental conditions affecting the plurality of sensor platforms.

Example 18 is a computer program product comprising one or more non-transitory machine-readable mediums having instructions encoded thereon that when executed by at least one processor cause a sensor platform to perform a method of data aggregation in a distributed sensor network. The method comprises acquiring, with the sensor platform, own sensor data about an environment in which the distributed sensor network is located, receiving, with the sensor platform, a sensor ledger from at least one other sensor platform in the distributed network, the sensor ledger comprising a plurality of ledger entries, wherein individual ledger entries of the plurality of ledger entries include a respective portion of other sensor data and an identifier that identifies an individual other sensor platform as a source of the respective portion of the other sensor data, and wherein the individual ledger entries are cryptographically linked to one another in the sensor ledger, and producing, with the sensor platform, a fused sensor view based on the own sensor data and a selected portion of the other sensor data from the sensor ledger, wherein the selected portion of the other sensor data is selected by the sensor platform based on a trust setting of the sensor platform and levels of trust assigned by the sensor platform to respective other sensor platforms in the distributed sensor network.

Example 19 includes the computer program product of Example 18, wherein the method further comprises, with the sensor platform, updating the sensor ledger to produce an updated sensor ledger by recording the own sensor data as an additional ledger entry in the sensor ledger, the additional ledger entry including the own sensor data and an identifier that identifies the sensor platform as a source of the own the sensor data, wherein updating the sensor ledger further includes cryptographically linking the additional ledger entry to at least one other ledger entry of the plurality of ledger entries in the updated sensor ledger.

Example 20 includes the computer program product of one of Examples 18 or 19, wherein the other sensor data includes a first portion from a first other sensor platform in the distributed sensor network and a second portion from a second other sensor platform in the distributed sensor network, and the method comprises assigning, by the sensor platform, a first level of trust to the first other sensor platform, and assigning, by the sensor platform, a second level of trust to the second other sensor platform, the second level of trust being higher trust level than the first level of trust, and wherein, producing the fused sensor view comprises, based on the trust setting of the sensor platform being a first trust setting, selecting the selected portion of the other sensor data to include the first and second portions of the other sensor data, or based on the trust setting of the sensor platform being a second trust setting, higher than the first trust setting, selecting the selected portion of the other sensor data to include the second portion of the other sensor data and exclude the first portion of the other sensor data.

Example 21 includes the computer program product of any one of Examples 18-20, wherein the method further comprises changing the trust setting of the sensor platform based on a user input.

Example 22 is a method of data sharing in a distributed sensor network that includes a plurality of sensor platforms. The method comprises acquiring sensor data about an environment in which the distributed sensor network is located using the plurality of sensor platforms, recording the sensor data as ledger entries in a sensor ledger, individual ledger entries including a respective portion of the sensor data and an identifier that identifies an individual sensor platform from among the plurality of sensor platforms as a source of the respective portion of the sensor data, wherein the individual ledger entries are cryptographically linked to one another in the sensor ledger, transmitting the sensor ledger among the plurality of sensor platforms, and producing, with at least one sensor platform from among the plurality of sensor platforms, a fused sensor view based on a selected portion of the sensor data from the sensor ledger, wherein the selected portion of the sensor data is selected by the at least one sensor platform based on a trust setting of the at least one sensor platform and levels of trust assigned by the at least one sensor platform to respective other sensor platforms among the plurality of sensor platforms.

Example 23 includes the method of Example 22, further comprising producing, with a first sensor platform from among the plurality of sensor platforms, a first ledger entry in the sensor ledger, the first ledger entry including a first portion of the sensor data and a first identifier that identifies the first sensor platform as a source of the first portion of the sensor data, and transmitting the sensor ledger to a second sensor platform from among the plurality of sensor platforms, wherein transmitting sensor ledger includes adding a second ledger entry to the sensor ledger, the second ledger entry including the first identifier and first transaction data indicating transmission of the sensor ledger by the first sensor platform, wherein the second ledger entry is cryptographically linked to the first ledger entry.

Example 24 includes the method of Example 23, further comprising receiving the sensor ledger at the second sensor platform, and with the second sensor platform, adding a third ledger entry to the sensor ledger, the third ledger entry including a second identifier that identifies the second sensor platform and second transaction data indicating reception of the sensor ledger by the second sensor platform, wherein the third ledger entry is cryptographically linked to the second ledger entry.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and examples have been described herein. The features, aspects, and examples are susceptible to combination with one another as well as to variation and modification, as will be appreciated in light of this disclosure. The present disclosure should, therefore, be considered to encompass such combinations, variations, and modifications.

What is claimed is:

1. A sensor platform comprising:
at least one sensor configured to acquire sensor data about an environment in which the sensor platform is located;
a wireless communication interface; and
a computing platform configured to control the sensor platform to
acquire first sensor data using the at least one sensor,
acquire second sensor data, via the wireless communication interface, from at least one other sensor platform, and
display, via a user interface, a fused sensor view that includes the first sensor data and includes or excludes the second sensor data based on a level of trust assigned to the at least one other sensor platform and a trust setting of the sensor platform.

2. The sensor platform of claim 1, wherein the second sensor data includes a first portion from a first other sensor platform assigned a first level of trust, and a second portion from a second other sensor platform assigned a second level of trust that is a higher trust level than the first level of trust; and
wherein, the computing platform is configured to:
based on the trust setting of the sensor platform being a first trust setting, display the fused sensor view including the first and second portions of the second sensor data, or
based on the trust setting of the sensor platform being a second trust setting, higher than the first trust setting, display the fused sensor view including the second portion of the second sensor data and excluding the first portion of the second sensor data.

3. The sensor platform of claim 2, wherein the first portion of the second sensor data includes a first identifier that identifies the first other sensor platform, and the second portion of the second sensor data includes a second identifier that identifies the second other sensor platform.

4. The sensor platform of claim 3, wherein the computing platform includes a computer-readable storage medium that stores information linking the first level of trust to the first identifier and the second level of trust to the second identifier.

5. The sensor platform of claim 3, wherein the second sensor data includes a sensor ledger in which the first portion of the second sensor data is cryptographically linked to the first identifier, and the second portion of the second sensor data is cryptographically linked to the second identifier and to the first portion of the second sensor data.

6. The sensor platform of claim 5, wherein to cryptographically link the second portion of the second sensor data to the first portion of the second sensor data, a ledger entry including the second portion of the second sensor data includes a cryptographic hash of the first portion of the second sensor data.

7. The sensor platform of claim 2, wherein the computing platform is configured to temporarily assign the first level of trust to the second other sensor platform based on location information about the second other sensor platform.

8. The sensor platform of claim 1, wherein the computing platform is configured to:
add the first sensor data as a ledger entry to a sensor ledger, wherein the ledger entry includes an identifier that identifies the sensor platform and is cryptographically linked to at least one previous ledger entry in the sensor ledger; and
transmit the sensor ledger, including the ledger entry, to the at least one other sensor platform via the wireless communication interface.

9. The sensor platform of claim 1, wherein the computing platform is configured to change the trust setting based on a user input received via the user interface.

10. A method of data sharing in a distributed sensor network that includes a plurality of sensor platforms, the method comprising:
acquiring own sensor data about an environment in which the distributed sensor network is located using a sensor platform from among the plurality of sensor platforms;
receiving a sensor ledger from at least one other sensor platform in the distributed sensor network, the sensor ledger comprising a plurality of ledger entries, wherein individual ledger entries of the plurality of ledger entries include a respective portion of other sensor data and an identifier that identifies an individual sensor platform from among the plurality of sensor platforms as a source of the respective portion of the other sensor data, wherein the individual ledger entries are cryptographically linked to one another in the sensor ledger; and
producing, with the sensor platform, a fused sensor view based on the own sensor data and a selected portion of the other sensor data from the sensor ledger, wherein the selected portion of the other sensor data is selected by the sensor platform based on a trust setting of the sensor platform and levels of trust assigned by the sensor platform to respective other sensor platforms among the plurality of sensor platforms.

11. The method of claim 10, further comprising:
with the sensor platform, updating the sensor ledger to produce an updated sensor ledger by recording the own sensor data as an additional ledger entry in the sensor ledger, the additional ledger entry including the own sensor data and an identifier that identifies the sensor platform as a source of the own the sensor data, wherein updating the sensor ledger further includes cryptographically linking the additional ledger entry to at least one other ledger entry of the plurality of ledger entries in the updated sensor ledger.

12. The method of claim 11, wherein cryptographically linking the additional ledger entry to the at least one other ledger entry includes producing a cryptographic hash of the at least one other ledger entry and including the cryptographic hash in the additional ledger entry.

13. The method of claim 11, further comprising:
transmitting the updated sensor ledger from the sensor platform to one or more other sensor platforms in the distributed sensor network.

14. The method of claim 10, wherein the other sensor data includes a first portion from a first other sensor platform in the plurality of sensor platforms and a second portion from a second other sensor platform in the plurality of sensor platforms, wherein the first other sensor platform is assigned a first level of trust by the sensor platform, and the second other sensor platform is assigned a second level of trust by the sensor platform, the second level of trust being higher trust level than the first level of trust; and
wherein, producing the fused sensor view comprises:
based on the trust setting of the sensor platform being a first trust setting, selecting the selected portion of the other sensor data to include the first and second portions of the other sensor data, or
based on the trust setting of the sensor platform being a second trust setting, higher than the first trust setting, selecting the selected portion of the other sensor data to include the second portion of the other sensor data and exclude the first portion of the other sensor data.

15. The method of claim 10, further comprising:
changing the trust setting of the sensor platform based on a user input.

16. The method of claim 10, wherein the sensor platform is configured to assign the first level of trust to the first other sensor platform and to assign the second level of trust to the second other sensor platform based on one or more trust factors, wherein the trust factors include locations of the plurality of sensor platforms, operators of the plurality of sensor platforms, sensor capabilities of the plurality of sensor platforms, and/or environmental conditions affecting the plurality of sensor platforms.

17. A computer program product comprising one or more non-transitory machine-readable mediums having instructions encoded thereon that when executed by at least one processor cause a sensor platform to perform a method of data aggregation in a distributed sensor network, the method comprising:
acquiring, with the sensor platform, own sensor data about an environment in which the distributed sensor network is located;
receiving, with the sensor platform, a sensor ledger from at least one other sensor platform in the distributed network, the sensor ledger comprising a plurality of ledger entries, wherein individual ledger entries of the plurality of ledger entries include a respective portion of other sensor data and an identifier that identifies an individual other sensor platform as a source of the respective portion of the other sensor data, and wherein the individual ledger entries are cryptographically linked to one another in the sensor ledger; and
producing, with the sensor platform, a fused sensor view based on the own sensor data and a selected portion of the other sensor data from the sensor ledger, wherein the selected portion of the other sensor data is selected by the sensor platform based on a trust setting of the sensor platform and levels of trust assigned by the sensor platform to respective other sensor platforms in the distributed sensor network.

18. The computer program product of claim 17, wherein the method further comprises:
with the sensor platform, updating the sensor ledger to produce an updated sensor ledger by recording the own sensor data as an additional ledger entry in the sensor ledger, the additional ledger entry including the own sensor data and an identifier that identifies the sensor platform as a source of the own the sensor data, wherein updating the sensor ledger further includes cryptographically linking the additional ledger entry to at least one other ledger entry of the plurality of ledger entries in the updated sensor ledger.

19. The computer program product of claim 17, wherein the other sensor data includes a first portion from a first other sensor platform in the distributed sensor network and a second portion from a second other sensor platform in the distributed sensor network, the method comprising:
assigning, by the sensor platform, a first level of trust to the first other sensor platform; and
assigning, by the sensor platform, a second level of trust to the second other sensor platform, the second level of trust being higher trust level than the first level of trust; and
wherein, producing the fused sensor view comprises:
based on the trust setting of the sensor platform being a first trust setting, selecting the selected portion of the other sensor data to include the first and second portions of the other sensor data, or
based on the trust setting of the sensor platform being a second trust setting, higher than the first trust setting, selecting the selected portion of the other sensor data to include the second portion of the other sensor data and exclude the first portion of the other sensor data.

20. The computer program product of claim 17, wherein the method further comprises changing the trust setting of the sensor platform based on a user input.
